(19) United States
(12) Patent Application Publication
(10) Pub. No.: US 2015/0101194 A1
(43) Pub. Date: Apr. 16, 2015

(54) PET NAIL CLIPPERS

(71) Applicant: ShunYi Pet Products (Shenzhen) Co., Ltd., Shenzhen (CN)

(72) Inventor: LIN JUI-TSANG, Shenzhen (CN)

(73) Assignee: ShunYi Pet Products (Shenzhen) Co., Ltd., Shenzhen (CN)

(21) Appl. No.: 14/054,857

(22) Filed: Oct. 16, 2013

(51) Int. Cl. A01K 13/00

(52) U.S. Cl. CPC A01K 13/00
USPC 30/29

(57) ABSTRACT

Pet nail clippers contains a fixed grip, a movable grip connected with the fixed grip, a housing, an adjusting bolt, and a cutting assembly. The housing includes a beak portion and a neck portion coupling with the fixed grip which includes a receiving cavity. The cutting assembly includes a movable blade and a fixed blade disposed in the receiving cavity and extending out of the beak portion, and the movable blade contacts with the fixed blade and extends out of the beak portion. The movable blade is coupled with a driving rod connecting with the movable grip, the driving rod includes a second end coupling with a resilient element. The resilient element includes a second end mounted on the fixed grip, the housing also includes a through hole communicating with the movable blade, such that the adjusting bolt inserts through the through hole to abut against the movable blade.

### FIELD OF THE INVENTION

The present invention relates to pet nail clippers.

### BACKGROUND OF THE INVENTION

A conventional pet nail clippers contain a fixed blade and a movable blade moving relative to the fixed blade. The fixed blade is made of plastic material, so it is broken easily after a period of using time. In addition, the fixed blade cannot contact with the movable blade completely, so the conventional pet nail clippers cannot trim pet's nails sharply.

The present invention has arisen to mitigate and/or obviate the afore-described disadvantages.

### SUMMARY OF THE INVENTION

The primary object of the present invention is to provide pet nail clippers which adjust a connecting tightness of a movable blade and a fixed blade.

To obtain the above objective, pet nail clippers provided by the present invention contains: a fixed grip, a movable grip connected with the fixed grip, a housing, an adjusting bolt, and a cutting assembly.

The housing is hollow and includes a beak portion and a neck portion coupling with one end of the fixed grip, the fixed grip includes a receiving cavity defined on the first end thereof, the cutting assembly includes a movable blade and a fixed blade disposed in the receiving cavity and extending out of the beak portion of the housing, and the movable blade contacts with a top surface of the fixed blade and extends out of the beak portion of the housing, the movable blade is coupled with a first end of a driving rod which is in connection with the movable grip, the driving rod includes a second end coupling with a first end of a resilient element, the resilient element includes a second end mounted on the fixed grip, such that after the movable grip is rotated, the resilient element pulls the driving rod, and the driving rod drives the movable blade to move forwardly relative to the fixed blade, the housing also includes a through hole defined therein and communicating with the movable blade, such that the adjusting bolt inserts through the through hole to abut against the movable blade.

### BRIEF DESCRIPTION OF THE DRAWINGS

FIG. 1 is a perspective view showing the exploded components of pet nail clippers according to a preferred embodiment of the present invention.

FIG. 2 is a perspective view showing the assembly of a housing of the pet nail clippers according to the preferred embodiment of the present invention.

FIG. 3 is a perspective view showing the assembly of a fixed grip of the pet nail clippers according to the preferred embodiment of the present invention.

FIG. 4 is a cross sectional view showing the assembly of the fixed grip of the pet nail clippers according to the preferred embodiment of the present invention.

FIG. 5 is another perspective view showing the assembly of the pet nail clippers according to the preferred embodiment of the present invention.

FIG. 6 is a perspective view showing the operation of the pet nail clippers according to the preferred embodiment of the present invention.

### DETAILED DESCRIPTION OF THE PREFERRED EMBODIMENTS

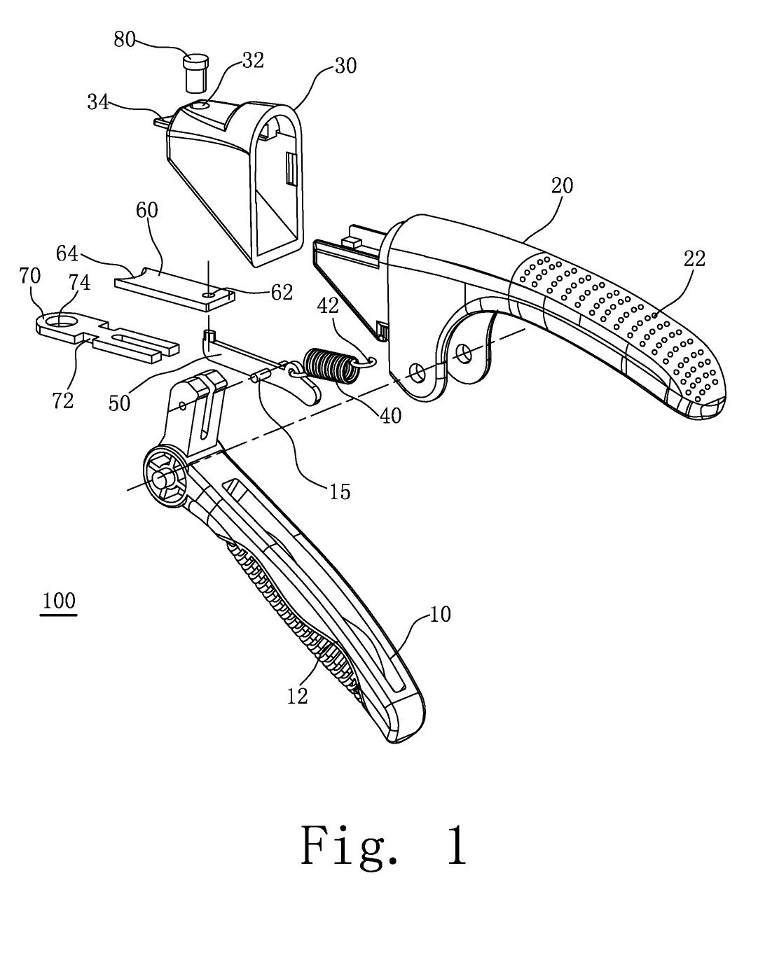

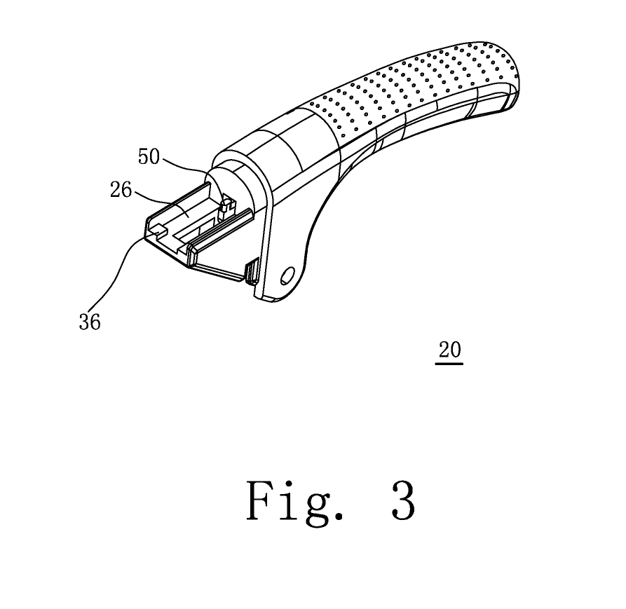

With reference to FIGS. 1-3, pet nail clippers 100 according to a preferred embodiment of the present invention comprises: a fixed grip 20, a movable grip 20 connected with the fixed grip 10, a housing 30, an adjusting bolt 80, and a cutting assembly.

The housing 30 is hollow and includes a beak portion 38 and a neck portion 39 coupling with one end of the fixed grip 20. The fixed grip 20 includes a receiving cavity 26 defined on the first end thereof. The cutting assembly includes a movable blade 60 and a fixed blade 70 disposed in the receiving cavity 26 and extending out of the beak portion 38 of the housing 30, and the movable blade 60 contacts with a top surface of the fixed blade 70 and extends out of the beak portion 38 of the housing 30. In addition, the movable blade 60 is coupled with a first end of a driving rod 50 which is in connection with the movable grip 10, the driving rod 50 includes a second end coupling with a first end of a resilient element 40. In this embodiment, the resilient element 40 is a spring and includes a second end mounted on the fixed grip 20. In operation, the fixed grip 20 and the movable grip 10 are held, by user's hands, and then the movable grip 20 is rotated so that the resilient element 40 pulls the driving rod 50, thereafter the driving rod 50 drives the movable blade 60 to move forwardly relative to the fixed blade 70, thus trimming pet's nails.

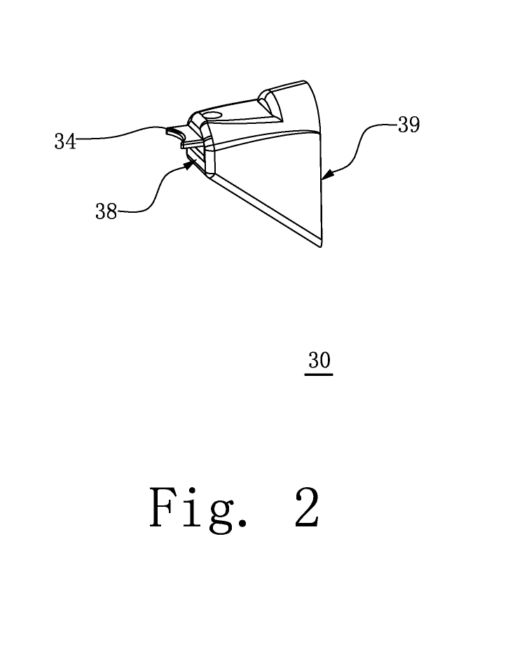

As shown in FIGS. 1 and 2, the housing 30 also a through hole 32 defined therein and communicating with the movable blade 60, such that the adjusting bolt 80 inserts through the through hole 32 to abut against the movable blade 60, and after the adjusting bolt 80 is rotated, it drives the movable blade 60 to press the fixed blade 70. The adjusting bolt 80 includes a washer (not shown) for providing a buffer and protection function.

The fixed blade 70 includes an orifice 74 formed on a front end thereof so as to receive the pet's nails, and the movable blade 60 includes a semi-circular cutout 64 arranged on a front end thereof, wherein the semi-circular cutout 64 aligns with the orifice 74 so that after the pet's nails are put in the orifice 74, the movable blade 60 is driven to moved forwardly relative to the fixed blade 70, thus trimming the pet's nails.

Moreover, the fixed blade 70 includes two retaining recesses 72 formed on two sides thereof, and the receiving cavity 26 has two locking blocks 36 secured therein so as to retain with the two recesses 72 of the fixed block 70, such that the fixed blade 70 is connected with the fixed grip 20. The housing 30 further includes a lid 34 extending out of the beak portion 38 and covering a part of the movable blade 60 which extends out of the beak 38, such that the movable blade 60 is protected by the lid 34, thus prolonging s service life of the movable blade 60.

The movable blade 60 also includes an aperture 62 defined on a first end thereof which couples with the driving rod 50, and the driving rod 50 includes an fitting section extending upwardly from the first end thereof so as to fit with the aperture 62, such that the movable blade 60 is driven by the driving rod 50 to move. The resilient element 40 includes two hooks 42 disposed on the first end and the second end thereof, and the fixed grip 20 includes a column 24 for hooking with one of the two hooks 42 which is disposed on the second end of the resilient element 40, and the driving rod 50 includes a pore defined on the second end thereof for hooking with the other of the two hooks 42 which is disposed on the first end of the resilient element 40.

The movable grip 10 includes an uneven portion 12 formed thereon, and the fixed grip 20 includes a plurality of bosses 22, such that the user can hold the movable grip 10 and the fixed grip 20 securely by using the uneven portion 12 and the plurality of bosses 22.

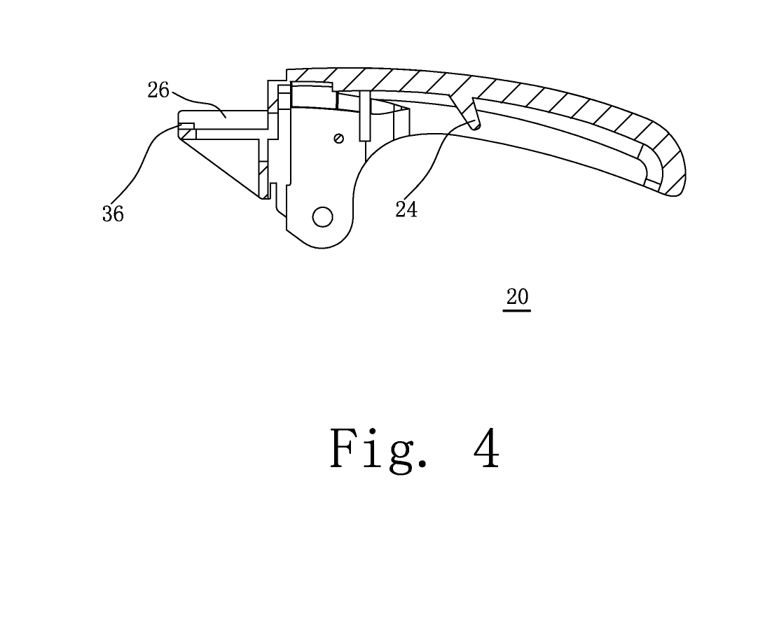

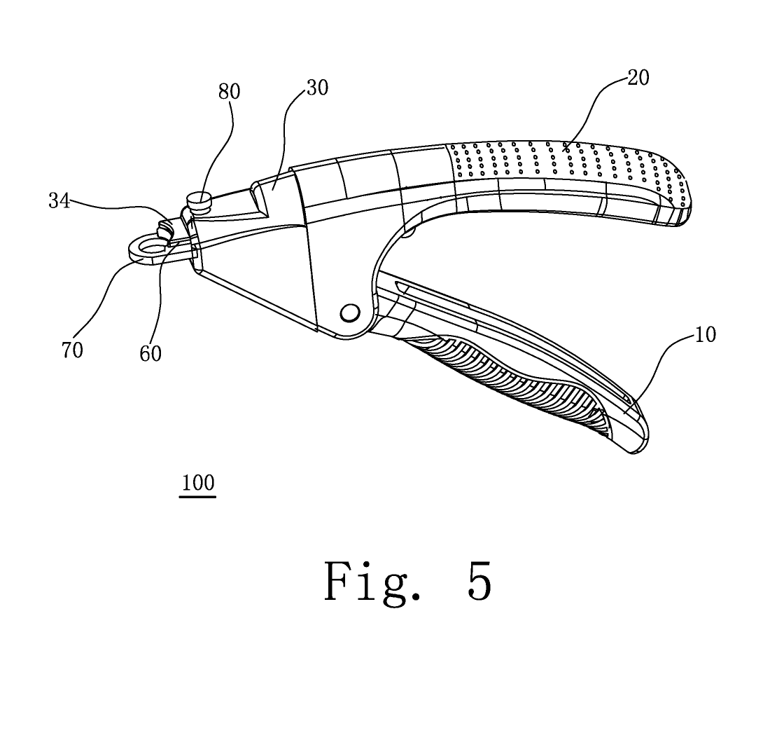

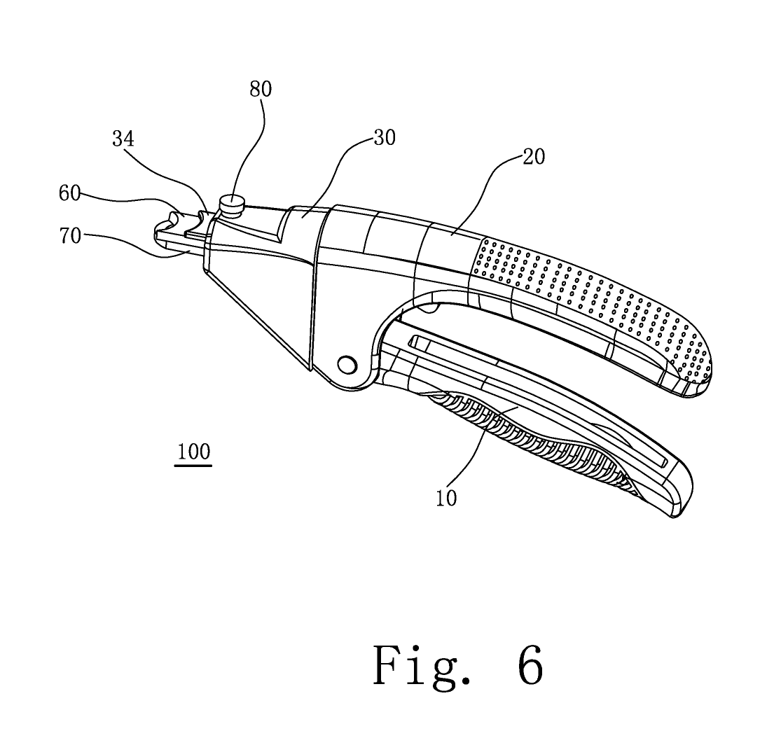

As illustrated to FIGS. 4-6, in operation, the movable grip 10 and the movable grip 20 are held, and the movable grip 40 is rotated to drive the driving rod 50, and then the driving rod 50 drives the movable grip 60 to move relative to the fixed blade 70, thus trimming the pet's nails.

Thereby, the adjusting bolt inserts through the through hole to abut against the movable blade, and after the adjusting bolt is rotated, it drives the movable blade to press the fixed blade, thereby adjusting a connecting tightness of the movable blade and the fixed blade.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A pet nail clippers comprising:
a fixed grip, a movable grip connected with the fixed grip, a housing, an adjusting bolt, and a cutting assembly, characterized in that:
the housing is hollow and includes a beak portion and a neck portion coupling with one end of the fixed grip, the fixed grip includes a receiving cavity defined on the first end thereof, the cutting assembly includes a movable blade and a fixed blade disposed in the receiving cavity and extending out of the beak portion of the housing, and the movable blade contacts with a top surface of the fixed blade and extends out of the beak portion of the housing, the movable blade is coupled with a first end of a driving rod which is in connection with the movable grip, the driving rod includes a second end coupling with a first end of a resilient element, the resilient element includes a second end mounted on the fixed grip, such that after the movable grip is rotated, the resilient element pulls the driving rod, and the driving rod drives the movable blade to move forwardly relative to the fixed blade, the housing also includes a through hole defined therein and communicating with the movable blade, such that the adjusting bolt inserts through the through hole to abut against the movable blade.

2. The pet nail clippers as claimed in claim 1, wherein the adjusting bolt includes a washer.

3. The pet nail clippers as claimed in claim 1, wherein the fixed blade includes an orifice formed on a front end thereof so as to receive pet's nails, and the movable blade includes a semi-circular cutout arranged on a front end thereof, wherein the semi-circular cutout aligns with the orifice.

4. The pet nail clippers as claimed in claim 3, wherein the fixed blade includes two retaining recesses formed on two sides thereof, and the receiving cavity has two locking blocks secured therein so as to retain with the two recesses of the fixed block, such that the fixed blade is connected with the fixed grip.

5. The pet nail clippers as claimed in claim 1, wherein the housing further includes a lid extending out of the beak portion and covering a part of the movable blade which extends out of the beak.

6. The pet nail clippers as claimed in claim 1, wherein the movable blade also includes an aperture defined on a first end thereof which couples with the driving rod, and the driving rod includes an fitting section extending upwardly from the first end thereof so as to fit with the aperture.

7. The pet nail clippers as claimed in claim 1, wherein the resilient element includes two hooks disposed on the first end and the second end thereof, and the fixed grip includes a column for hooking with one of the two hooks which is disposed on the second end of the resilient element, and the driving rod includes a pore defined on the second end thereof for hooking with the other of the two hooks which is disposed on the first end of the resilient element.

8. The pet nail clippers as claimed in claim 1, wherein the movable grip includes an uneven portion formed thereon.

9. The pet nail clippers as claimed in claim 1, wherein the fixed grip includes a plurality of bosses.
